(19) United States
(12) Patent Application Publication
(10) Pub. No.: US 2009/0083020 A1
(43) Pub. Date: Mar. 26, 2009

(54) ALTERNATE TASK PROCESSING TIME MODELING

(75) Inventors: Jay W. Benayon, Thornhill (CA); Curtis R. Miles, Markham (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/859,289

(22) Filed: Sep. 21, 2007

(51) Int. Cl. G06F 9/44

(52) U.S. Cl. 703/20

(57) ABSTRACT

Embodiments of the present invention address deficiencies of the art in respect to process modeling and provide a method, system and computer program product for modeling alternate processing times based on user supplied expressions. In one embodiment of the invention, a method for modeling alternate processing times based on user supplied expressions can be provided. The method can include loading simulation variables for a simulated task in a model, computing a duration of time for the simulated task based upon the simulation variables, and simulating execution of the simulated task for the computed duration of time. For example, loading simulation variables for a simulated task in a model can include loading a level of expertise for a role assigned to the task, loading a time of day for executing the task, or loading a time of year for executing the task.

### BACKGROUND OF THE INVENTION

1. Field of the Invention

The present invention relates to the field of modeling and simulation and more particularly to processing time simulation for attribute processing in a modeling environment.

2. Description of the Related Art

Process modeling and simulation relates to the modeling and simulation of dynamic or static systems, which can include, but are not limited to, enterprise management systems, engineering systems, networked information technology systems, utility systems, utility computing systems, autonomic computing systems, on-demand systems, electric power grids, biological systems, medical systems, weather systems, financial market systems, and business process systems. Such systems can be modeled and simulated for a variety of purposes including monitoring, analysis, control, design, simulation, and management.

A process model is an abstract description of a process such as a business process or any other process related to the lifecycle of a system. The abstract description of the process model can include sufficient detail required by a simulation engine for exercising the process model with one or more scenarios to determine a likely outcome. Process models generally specify one or more tasks or activities of a process and the relationship between the different tasks or activities. As part of the model, one or more events or conditions leading to the transition from one task or activity to the next can be specified. Models generally are expressed according to a specific format. Exemplary formats include Activity Decision Flow (ADF) Unified Modeling Language (UML) activity diagrams, and the Business Process Execution Language (BPEL), to name only a few.

Presently, model attributes such as tasks in a model are simulated to consume a discrete period of time to complete processing. For example, a task can be modeled to complete within a few minutes. Alternatively, a task can be modeled to complete over a uniform range of times, for example a task can be modeled to complete uniformly over a period of time range of minutes. Yet, in reality, the processing time of a task can vary according to other attributes of the model, for example the role of the person assigned to the task, or the time of day or date of the year of performing the task. The rigid specification of time consumption for a task, however, ignores reality.

### BRIEF SUMMARY OF THE INVENTION

Embodiments of the present invention address deficiencies of the art in respect to process modeling and provide a novel and non-obvious method, system and computer program product for modeling alternate processing times based on user supplied expressions, for instance those in a decision table. In one embodiment of the invention, a method for modeling alternate processing times based on user supplied decision table can be provided. The method can include loading simulation variables for a simulated attribute such as a simulated task in a model, computing a duration of time for the simulated attribute based upon the simulation variables, and simulating execution of the simulated attribute for the computed duration of time. For example, loading simulation variables for a simulated task in a model can include loading a level of expertise for a role assigned to the task, loading a time of day for executing the task, or loading a time of year for executing the task.

In one aspect of the embodiment, computing a duration of time for the simulated task based upon the simulation variables can include mapping different variable expressions for each task in the model to corresponding durations of execution, and evaluating a selected set of the variable expressions for the simulated task to select a duration of time for the simulated task. In another aspect of the embodiment, simulating execution of the simulated task for the computed duration of time can include determining required resources for the simulated task, scheduling the required resources for the computed duration of time, advancing a simulation clock for the computed duration of time, and releasing the required resources subsequent to advancing the simulation clock.

In another embodiment of the invention, a model simulation data processing system can be provided. The system can include a simulation engine executing in an operating environment in a host computing platform. The system further can include a variable task duration processor coupled to the simulation engine. In this regard, the processor can include program code enabled to compute and assign variable durations of execution to different tasks in a model under simulation in the simulation engine according to observed simulation variables for the model. Optionally, a mapping of variable expressions to corresponding durations of execution can be provided where the expressions each are dependent upon at least one of the simulation variables. Specifically, the mapping can be coupled to the processor for access by the processor in computing the variable durations of execution for the different tasks in the model.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a modeling data processing system configured for modeling alternate processing times based on user supplied expressions; and,

FIG. 2 is a flow chart illustrating a process for modeling alternate processing times based on user supplied expressions.

### DETAILED DESCRIPTION OF THE INVENTION

Embodiments of the present invention provide a method, system and computer program product for modeling data processing system configured for modeling alternate processing times based on user supplied expressions. In accordance with an embodiment of the present invention, different variable expressions, such as those in a decision table dependent upon variable criteria can be mapped to corresponding temporal durations for different attributes such as tasks in a process model subjected to simulation. At simulation time, for each of the different tasks, the different variable expressions can be evaluated to select one of the corresponding task durations. Thereafter, required resources for each of the different tasks can be blocked for the selected one of the corresponding task durations subsequent to which the required resources can be released. In this way, varying durations can be computed at simulation time for different tasks in the simulation of the process model.

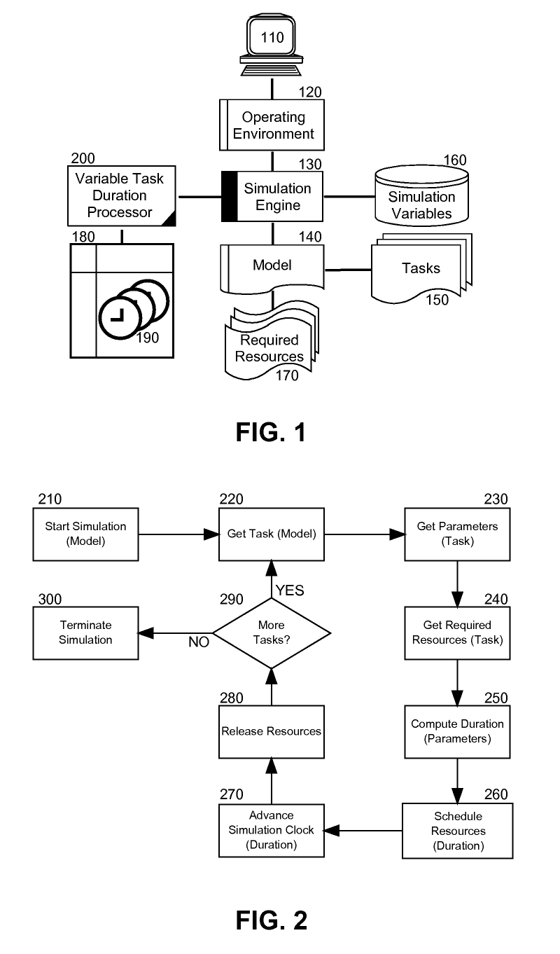

In further illustration, FIG. 1 is a schematic illustration of a modeling data processing system configured for modeling alternate processing times based on user supplied expressions. The system can include a host computing platform 110, for example a personal computer or a set of computers arranged to support a distributed simulation of a process model. The host computing platform 110 can include an operating environment 120, such as an operating system or a virtualized machine. A simulation engine 130 can execute in the operating environment 120. An example of a simulation engine 130 can include the WebSphere™ Business Modeler™ manufactured by International Business Machines Corporation of Armonk, N.Y. (WebSphere and Business Modeler are trademarks of International Business Machines Corporation).

The simulation engine 130 can be configured to process a simulation of a provided process model 140. In this regard, the provided process model 140 can include one or more process tasks or activities 150. Additionally, each one of the process tasks or activities 150 can utilize one or more required resources 170 such that remaining ones of the process tasks or activities 150 cannot utilize the required resources 170 during the execution of each one of the process tasks or activities 150.

Notably, variable task duration processor 200 can be coupled to the simulation engine 130. The variable task duration processor 200 can include program code enabled to compute a duration of execution 190 for the different tasks or activities 150. In particular, a mapping 180 can be coupled to and managed by the variable task duration processor 200. The mapping 180 can provide a table of expressions to durations. The expressions can be based upon one or more simulation variables 160 managed by the simulation engine 130 during simulation of the model 140. A positive evaluation of an expression in the mapping 180 can produce a duration 190 of execution to be assigned to a particular one of the tasks or activities 150 during simulation of the model 140.

For example, the mapping 180 can include for a flat tire changing task:

| Task | Duration | Criteria | Comment |
|---|---|---|---|
| Change Flat | | | |
| Tire | | | |
| | 10 min | (assignedResourceRoleQualification( ) = | Certified tire |
| | | ‘CertifiedTireFixer’) | changer |
| | 15 min | (assignedResourceRoleQualification( ) = ‘Mechanic’) | Mechanic |
| | 30 min | (month(SimClock) >= 4 AND | Spring/Summer |
| | | month(SimClock) <= 9) AND (hour(SimClock) >= 7 | day |
| | | AND hour(SimClock) <= 17) | |
| | 60 min | (month(SimClock) >= 4 AND | Spring/Summer |
| | | month(SimClock) <= 9) AND NOT (hour(SimClock) >= 7 | night |
| | | AND hour(SimClock) <= 17) | |
| | 90 min | NOT (month(SimClock) >= 4 AND | Fall/Winter day |
| | | month(SimClock) <= 9) AND (hour(SimClock) >= 7 | |
| | | AND hour(SimClock) <= 17) | |
| | uniform | NOT (month(SimClock) >= 4 AND | Fall/Winter |
| | (120, 180) | month(SimClock) <= 9) AND NOT (hour(SimClock) >= 7 | night |
| | | AND hour(SimClock) <= 17) | |

In the foregoing example, it will be clear to the skilled artisan that the duration of time for changing a flat tire can vary according to whether the role assigned to the task is more experienced in the task than ordinary, whether the time of day for the task is day or night, and whether the time of year of the task is the Summer or Spring, or Fall or Winter.

In yet further illustration, FIG. 2 is a flow chart illustrating a process for modeling alternate processing times based on user supplied expressions. Beginning in block 210, a simulation of a model can be initiated and in block 220, a first task for the model can be retrieved for processing. In block 230, parameters for the task can be identified and in block 240, the required resources for the task can be determined. Thereafter, in block 250 a duration of time can be computed for the task based upon the identified parameters for the task and in block 260, the required resources can be scheduled for the task for the computed duration of time.

In block 270, the simulation clock can be advanced by the computed duration of time and in block 280, the required resources can be released. In decision block 290, if more tasks remain to be processed in the model, in block 220 the process can repeat for a next task in the model and the process can continue to repeat until no further tasks in the model remain to be processed. Subsequently, the simulation can terminate in block 300.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for modeling alternate processing times based on user supplied expressions, the method comprising:
loading simulation variables for a simulated attribute in a model;
computing a duration of time for the simulated attribute based upon the simulation variables; and,
simulating execution of the simulated attribute for the computed duration of time.

2. The method of claim 1, wherein the simulated attribute is a simulated task.

3. The method of claim 2, wherein loading simulation variables for a simulated task in a model, comprises loading a level of expertise for a role assigned to the task.

4. The method of claim 2, wherein loading simulation variables for a simulated task in a model, comprises loading a time of day for executing the task.

5. The method of claim 2, wherein loading simulation variables for a simulated task in a model, comprises loading a time of year for executing the task.

6. The method of claim 2, wherein computing a duration of time for the simulated task based upon the simulation variables, comprises:
mapping different variable expressions for each task in the model to corresponding durations of execution; and,
evaluating a selected set of the variable expressions for the simulated task to select a duration of time for the simulated task.

7. The method of claim 2, wherein simulating execution of the simulated task for the computed duration of time, comprises:
determining required resources for the simulated task;
scheduling the required resources for the computed duration of time;
advancing a simulation clock for the computed duration of time; and,
releasing the required resources subsequent to advancing the simulation clock.

8. A model simulation data processing system comprising:
a simulation engine executing in an operating environment in a host computing platform; and,
a variable task duration processor coupled to the simulation engine, the processor comprising program code enabled to compute and assign variable durations of execution to different tasks in a model under simulation in the simulation engine according to observed simulation variables for the model.

9. The system of claim 8, further comprising a mapping of variable expressions dependent upon at least one of the simulation variables, to corresponding durations of execution, the mapping being coupled to the processor for access by the processor in computing the variable durations of execution for the different tasks in the model.

10. A computer program product comprising a computer usable medium embodying computer usable program code for modeling alternate processing times based on user supplied expressions, the computer program product comprising:
computer usable program code for loading simulation variables for a simulated attribute in a model;
computer usable program code for computing a duration of time for the simulated attribute based upon the simulation variables; and,
computer usable program code for simulating execution of the simulated attribute for the computed duration of time.

11. The computer program product of claim 10, wherein the simulated attribute is a simulated task.

12. The computer program product of claim 11, wherein the computer usable program code for loading simulation variables for a simulated task in a model, comprises computer usable program code for loading a level of expertise for a role assigned to the task.

13. The computer program product of claim 11, wherein the computer usable program code for loading simulation variables for a simulated task in a model, comprises computer usable program code for loading a time of day for executing the task.

14. The computer program product of claim 11, wherein the computer usable program code for loading simulation variables for a simulated task in a model, comprises computer usable program code for loading a time of year for executing the task.

15. The computer program product of claim 11, wherein the computer usable program code for computing a duration of time for the simulated task based upon the simulation variables, comprises:
computer usable program code for mapping different variable expressions for each task in the model to corresponding durations of execution; and,
computer usable program code for evaluating a selected set of the variable expressions for the simulated task to select a duration of time for the simulated task.

16. The computer program product of claim 11, wherein the computer usable program code for simulating execution of the simulated task for the computed duration of time, comprises:
computer usable program code for determining required resources for the simulated task;
computer usable program code for scheduling the required resources for the computed duration of time;
computer usable program code for advancing a simulation clock for the computed duration of time; and,
computer usable program code for releasing the required resources subsequent to advancing the simulation clock.
